(19) United States
(12) Patent Application Publication
(10) Pub. No.: US 2020/0039864 A1
(43) Pub. Date: Feb. 6, 2020

(54) THERMAL BENDING MACHINE AND GLASS THERMAL BENDING DEVICE

(71) Applicant: AAC Technologies Pte. Ltd., Singapore city (SG)

(72) Inventors: Yuqin Yuan, Shenzhen (CN); Bo Xu, Shenzhen (CN); Wei Su, Shenzhen (CN)

(21) Appl. No.: 16/527,029

(22) Filed: Jul. 31, 2019

(30) Foreign Application Priority Data
Aug. 3, 2018 (CN) 201810880405.7

(51) Int. Cl. C03B 23/03; C03B 11/06

(52) U.S. Cl. CPC C03B 23/0305; C03B 11/06

(57) ABSTRACT

The present disclosure provides a thermal bending machine and a glass thermal bending device. The thermal bending machine comprising an upper die and a lower die matched with each other, the upper die comprising an upper clamping surface close to the lower die and a pressure receiving surface opposite to the clamping surface, the lower die comprising a lower clamping surface matched with the upper clamping surface and a bearing surface facing away from the upper die. The thermal bending machine further comprises a movable pushing member abutting against the lower extending portion and a movable driving member abutting against the upper extending portion, the moving direction of the movable pushing member is a direction in which it moves towards the lower mold plate, and the moving direction of the movable driving member is a direction in which it pushes the upper die to move towards the upper mold plate.

### FIELD OF THE DISCLOSURE

The present invention relates to the technical field of thermal bending machines, in particular to a thermal bending machine and a glass thermal bending device.

### DESCRIPTION OF RELATED ART

The existing glass mold in related art is formed by an upper mold and a lower mold for thermal bending. As the molding temperature of a glass product is higher and the molding time of the glass product is longer, the existing thermal bending machine is generally divided into a plurality of stations for continuous processing, generally comprising a heating station, a pressurizing station and a cooling station. In the glass processing process, a glass product is firstly placed in a mold, and then the mold is placed in the heating station for heating, so that the temperature of the mold and the glass gradually rises from a room temperature to a glass softening temperature; then, the mold is placed in the pressurizing station, and a pressing rod of the thermal bending machine moves downwards to drive an upper mold plate to move downwards, so that the upper mold and the lower mold are closed; finally, the mold is placed in the cooling station to cool the mold so that the temperature of the mold and the glass gradually decreases from the glass softening temperature to the room temperature.

The skilled person found that at least the following problems exist in the prior art: after the glass is molded at high temperature, the size and curved surface shape of the glass will change with the change of temperature. If the spacing between the upper mold and the lower mold cannot be adjusted according to the change of temperature, in the cooling process, the glass may wrap the mold to generate tensile stress or compressive stress, causing microcracks or even cracks in the glass product, reducing the yield of the finished glass product and increasing the production cost.

Therefore, it is desired to provide a thermal bending machine and a glass thermal bending device to overcome the aforesaid problems.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a sectional view of a thermal bending device provided by a first embodiment of the present invention; and

FIG. 2 is another sectional view of the thermal bending device provided by the first embodiment of the present invention.

### DETAILED DESCRIPTION

The present disclosure will be hereinafter described in detail below with reference to the attached drawings and embodiments thereof.

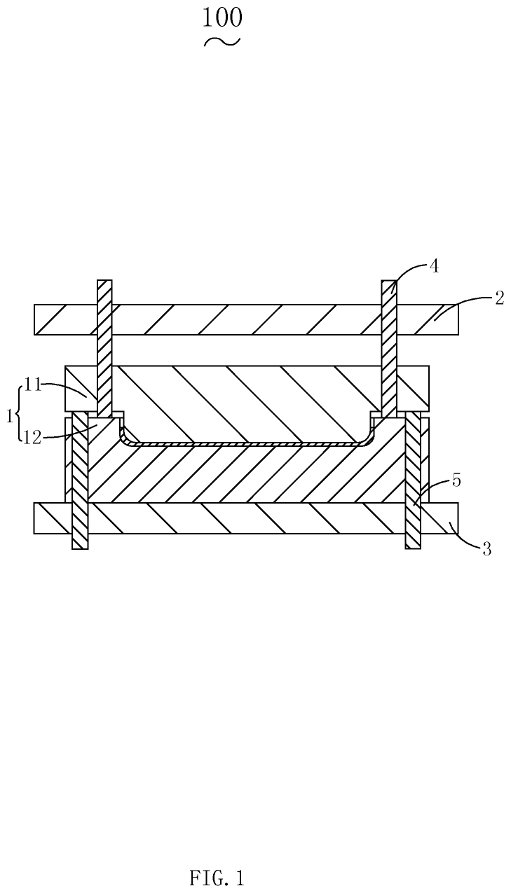

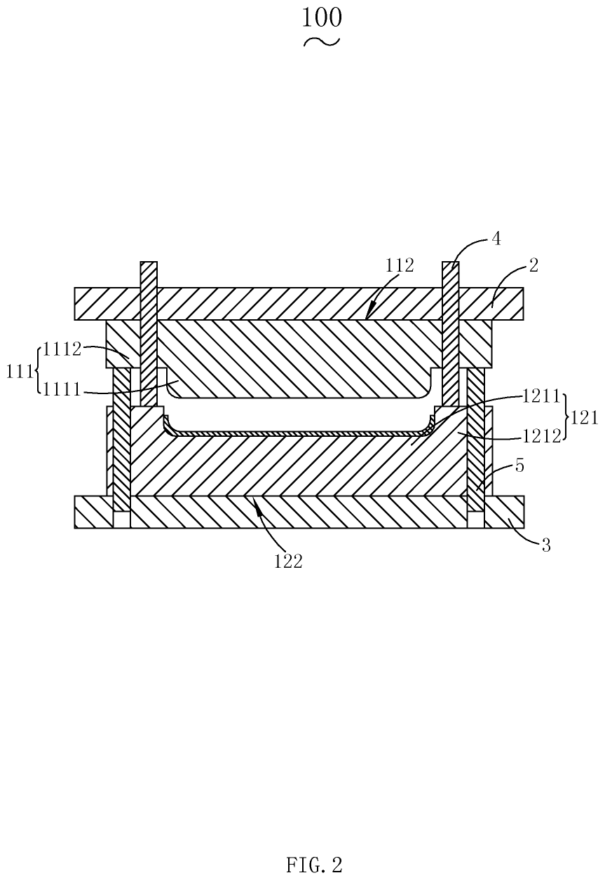

A first embodiment of the present invention relates to a thermal bending device, as shown in FIGS. 1 and 2.

The thermal bending machine 100 comprises a thermal bending mold 1, wherein the thermal bending mold 1 comprises an upper die 11 and a lower die 12 which are matched with each other, the upper die 11 comprises an upper clamping surface 111 close to the lower die 12 and a pressure receiving surface 112 opposite to the clamping surface 111, and the lower die 12 comprises a lower clamping surface 121 matched with the upper clamping surface 111 and a bearing surface 122 facing away from the upper die 11. The thermal bending machine 100 further comprises an upper mold plate 2 which is arranged on the side of the pressure receiving surface 112 of the upper die 11 and is configured to push the upper die 11; and a lower mold plate 3 which is opposite to the upper mold plate 2 and is configured for abutting against the bearing surface 122, wherein the upper clamping surface 111 comprises an upper clamping portion 1111 and an upper extending portion 1112 extending from the edge of the upper clamping portion 1111, and the lower clamping surface 121 comprises a lower clamping portion 1211 corresponding to the upper clamping portion 1111 and a lower extending portion 1212 corresponding to the upper extending portion 1112. The thermal bending machine 100 further includes a movable pushing member 4 abutting against the lower extending portion 1212, and a movable driving member 5 abutting against the extending portion 1112. The moving direction of the movable pushing members 4 is a direction in which it moves toward the lower mold plate 3, and the moving direction of the movable driving member 5 is a direction in which it moves toward the upper mold plate 2. Preferably, at least one of the movable driving member 5 and the movable pushing member 4 is preferably a push rod.

Compared with the prior art, according to the embodiment of the present invention, by providing the movable driving member 5 abutting against the upper extending portion 1112 and the movable pushing member 4 abutting against the lower extending portion 1212, the moving direction of the movable driving member 5 is a direction in which it moves toward the upper mold plate 2, and the moving direction of the movable pushing member 4 is a direction in which it moves toward the lower mold plate 3, so that the movable pushing member 4 moves downward to push and abut against the lower die 12 during the working process of the thermal bending mold 1 to prevent the lower die 12 from moving upward; the movable driving member 5 moves upward to open the upper die and lower die, so as to leave enough spacing between the upper die and lower die for demolding, thus avoiding the occurrence of “when the size and curved surface shape of the glass change with the change of temperature in the thermal bending machine, the glass may wrap the mold to generate tensile stress or compressive stress, resulting in microcracks or even cracks in the glass products”, thus improving the yield and production efficiency of the glass and reducing the production cost.

The implementation details of this embodiment will be described in detail below. The following is only for convenience of understanding the implementation details provided, and is not necessary to implement this embodiment.

In this embodiment, the movable pushing member 4 penetrates through the upper mold plate 2 and extends to the lower extending portion 1212, and one end of the movable pushing member 4 remote from the lower extending portion 1212 protrudes from the side of the upper mold plate 2 remote from the upper die 11. By protruding the movable pushing members 4 from the upper mold plate 2, when the movable pushing member 4 moves toward the lower mold plate 3, a force applying mechanism can more conveniently apply an urging force to the movable pushing member 4, thereby improving the working efficiency of the thermal bending machine 100.

It should be noted that the movable pushing member 4 penetrates through the upper mold plate 2 and the upper die 11 sequentially. The movable pushing member 4 can be directly abutted against the lower extending portion 1212 without relying on other structures, thus simplifying the manufacturing process of the thermal bending machine 100.

Specifically, the movable driving member 5 penetrates through the lower mold plate 3 and extends to the upper extending portion 1112, and one end of the movable driving member 5 remote from the upper extending portion 1112 protrudes from the side of the lower mold plate 3 remote from the lower die 12. By protruding the movable driving member 5 from the lower mold plate 3, when the movable driving member 5 moves toward the upper mold plate 2, a force applying mechanism can more conveniently apply an urging force to the movable driving member 5, thereby improving the working efficiency of the thermal bending machine 100.

Preferably, the movable driving member 5 penetrates through the lower mold plate 3 and the lower die 12 sequentially. The movable driving member 5 can be directly abutted against the upper extending portion 1112 without relying on other structure, thus simplifying the manufacturing process of the thermal bending machine 100.

It is worth mentioning that in this embodiment, the upper extending portion 1112 is disposed around the outer edge of the upper clamping portion 1111, and there are at least two movable driving members 5 and they are symmetrically abutted against the extending portions 1112. By arranging a plurality of movable drive members 5, and the plurality of movable drive members 5 being symmetrically abutted against the extending portion 1112, the upper die 11 is uniformly stressed in the movement process and can move in a direction away from and parallel to the lower mold plate 3.

It can be understood that in order to make the lower die 12 stressed uniformly and ensure that the lower die 12 will not move towards the upper mold plate 2, in this embodiment, the lower extending portion 1212 is disposed around the outer edge of the lower clamping portion 1211, and there are at least two movable pushing member 4 and they are symmetrically abutted against the lower extending portion 1212.

Specifically, the upper clamping portion 1111 protrudes towards the lower die 12, and the lower clamping portion 1211 is recessed away from the upper die 11.

A second embodiment of the present invention relates to a glass thermal bending device, which comprises a thermal bending machine 100, wherein a glass workpiece is clamped between an upper clamping portion 1111 and a lower clamping portion 1211.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A thermal bending machine comprising a thermal bending mold, the thermal bending mold comprising an upper die and a lower die matched with each other, the upper die comprising an upper clamping surface close to the lower die and a pressure receiving surface opposite to the clamping surface, the lower die comprising a lower clamping surface matched with the upper clamping surface and a bearing surface facing away from the upper die; wherein the thermal bending machine further comprises an upper mold plate which is arranged on one side of the pressure receiving surface of the upper die and is configured to push the upper die, and a lower mold plate which is opposite to the upper mold plate and is configured to abut against the bearing surface, and the thermal bending machine is characterized in that:
the upper clamping surface comprises an upper clamping portion and an upper extending portion extending from the edge of the upper clamping portion, and the lower clamping surface comprises a lower clamping portion corresponding to the upper clamping portion and a lower extending portion corresponding to the upper extending portion;
the thermal bending machine further comprises a movable pushing member abutting against the lower extending portion and a movable driving member abutting against the upper extending portion, wherein the moving direction of the movable pushing member is a direction in which it moves towards the lower mold plate, and the moving direction of the movable driving member is a direction in which it pushes the upper die to move towards the upper mold plate.

2. The thermal bending machine according to claim 1, characterized in that the movable pushing member penetrates through the upper mold plate and extends to the lower extending portion, and one end of the movable pushing member remote from the lower extending portion protrudes from one side of the upper mold plate remote from the upper die.

3. The thermal bending machine according to claim 2, characterized in that the movable pushing member penetrates through the upper mold plate and the upper die sequentially.

4. The thermal bending machine according to claim 3, characterized in that the movable driving member penetrates through the lower mold plate and extends to the upper extending portion, and one end of the movable driving member remote from the upper extending portion protrudes from one side of the lower mold plate remote from the lower die.

5. The thermal bending machine according to claim 4, characterized in that the movable driving member penetrates through the lower mold plate and the lower die sequentially.

6. The thermal bending machine according to claim 1, characterized in that the upper extending portion is disposed around the outer edge of the upper clamping portion, and there are at least two movable driving members and they are symmetrically abutted against the upper extending portion.

7. The thermal bending machine according to claim 6, characterized in that the lower extending portion is disposed around the outer edge of the lower clamping portion, and there are at least two movable pushing members and they are symmetrically abutted against the lower extending portion.

8. The thermal bending machine according to claim 1, characterized in that the upper clamping portion protrudes toward the lower die and the lower clamping portion is recessed away from the upper die.

9. The thermal bending machine according to claim 1, characterized in that at least one of the movable pushing member and the movable driving member is a push rod.

10. The thermal bending machine according to claim 2, characterized in that at least one of the movable pushing member and the movable driving member is a push rod.

11. The thermal bending machine according to claim 3, characterized in that at least one of the movable pushing member and the movable driving member is a push rod.

12. The thermal bending machine according to claim 4, characterized in that at least one of the movable pushing member and the movable driving member is a push rod.

13. The thermal bending machine according to claim 5, characterized in that at least one of the movable pushing member and the movable driving member is a push rod.

14. The thermal bending machine according to claim 6, characterized in that at least one of the movable pushing member and the movable driving member is a push rod.

15. The thermal bending machine according to claim 7, characterized in that at least one of the movable pushing member and the movable driving member is a push rod.

16. The thermal bending machine according to claim 8, characterized in that at least one of the movable pushing member and the movable driving member is a push rod.

17. A glass thermal bending device, characterized in that it comprises the thermal bending machine according to claim 1, wherein a glass workpiece is clamped between the upper clamping portion and the lower clamping portion.
